(19) United States
(12) Patent Application Publication
(10) Pub. No.: US 2014/0121973 A1
(43) Pub. Date: May 1, 2014

(54) Prognostics And Health Management Methods And Apparatus To Predict Health Of Downhole Tools From Surface Check

(71) Applicant: Schlumberger Technology Corporation, Sugar Land, TX (US)

(72) Inventors: Steven Eugene Buchanan, Pearland, TX (US); Gilbert Haddad, Houston, TX (US); Mahmoud Ismail Awad, Sugar Land, TX (US)

(73) Assignee: Schlumberger Technology Corporation, Sugar Land, TX (US)

(21) Appl. No.: 14/060,462

(22) Filed: Oct. 22, 2013

Related U.S. Application Data
(60) Provisional application No. 61/718,566, filed on Oct. 25, 2012.

(51) Int. Cl. G01M 5/00

(52) U.S. Cl. CPC G01M 5/0033
USPC 702/6

(57) ABSTRACT

A method includes analyzing historical surface check data to train classifiers indicative of data separation between healthy and unhealthy downhole tools. The method also includes developing, based on the classifiers, prognostics health and management algorithms to predict failures in the downhole tools.

### CROSS-REFERENCE TO RELATED APPLICATIONS

This application claims the benefit of U.S. Provisional Application No. 61/718,566, entitled “Prognostics and Health Management Methods to Predict Health of Downhole Tools from Surface Check,” filed Oct. 25, 2012, which is hereby incorporated herein by reference in its entirety.

### BACKGROUND OF THE INVENTION

Wellbores (also known as boreholes) are drilled to penetrate subterranean formations for hydrocarbon prospecting and production. During drilling operations, evaluations may be performed on the subterranean formation for various purposes, such as to locate hydrocarbon-producing formations and manage the production of hydrocarbons from these formations. To conduct formation evaluations, the drill string may include one or more drilling tools that test and/or sample the surrounding formation, or the drill string may be removed from the wellbore, and a wireline tool may be deployed into the wellbore to test and/or sample the formation. These drilling tools and wireline tools, as well as other wellbore tools conveyed on coiled tubing, drillpipe, casing or other conveyers, are also referred to herein as “downhole tools.” Downhole tools may be maintained through corrective or preventive maintenance programs. However, failures may still occur, which can result in inconvenient and costly downtime at the wellsite.

### SUMMARY

The present disclosure relates to a method that includes analyzing historical surface check data to train classifiers indicative of data separation between healthy and unhealthy downhole tools. The method also includes developing, based on the classifiers, prognostics health and management algorithms to predict failures in the downhole tools.

The present disclosure also relates to a method that includes performing a surface check on a downhole tool to generate surface check data, and analyzing the surface check data using prognostic health management algorithms to determine health of the downhole tool.

The present disclosure further relates to a downhole tool that includes a prognostics health management model having prognostics health management algorithms developed using historical surface check data. The downhole tool also includes a controller designed to automatically adjust operation of the downhole tool based on results of the prognostics health management model.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A is a schematic view of an embodiment of a downhole tool that may employ prognostic health management techniques, according to aspects of the present disclosure;

FIG. 1B is a schematic view of another embodiment of a downhole tool that may employ prognostic health management techniques, according to aspects of the present disclosure;

FIG. 2 is a schematic view of a coring module that may be employed in the downhole tools of FIGS. 1A and 1B, according to aspects of the present disclosure;

FIG. 3 is a flowchart depicting an embodiment of a method for developing a prognostics health management model, according to aspects of the present disclosure;

FIG. 4 is an illustration of an embodiment of well log data that can be employed to develop a prognostics health management model, according to aspects of the present disclosure;

FIG. 5 is an illustration of an embodiment of a principal component plot that can be employed to develop a prognostics health management model, according to aspects of the present disclosure;

FIG. 6 is an illustration of an embodiment of a scatter plot that can be employed to develop a prognostics health management model, according to aspects of the present disclosure;

FIG. 7 is an illustration of the scatter plot of FIG. 6, post-filtering, according to aspects of the present disclosure;

FIG. 8 is an illustration of an embodiment of a cluster analysis that can be employed to develop a prognostics health management model, according to aspects of the present disclosure;

FIG. 9 is a flowchart depicting an embodiment of a method for detecting tool health using a prognostics health management model, according to aspects of the present disclosure; and

FIG. 10 is a flowchart depicting another embodiment of a method for detecting tool health using a prognostics health management model, according to aspects of the present disclosure.

### DETAILED DESCRIPTION

It is to be understood that the present disclosure provides many different embodiments, or examples, for implementing different features of various embodiments. Specific examples of components and arrangements are described below to simplify the present disclosure. These are, of course, merely examples and are not intended to be limiting.

The present disclosure relates to prognostics and health management (PHM) for downhole tools. In particular, the present disclosure relates to the development and application of PHM models to downhole tools to detect or predict tool failures from surface checks. According to certain embodiments, the PHM models may be developed using anomaly detection techniques, diagnostics models, and prognostic models. The models are trained on data collected from the tool (historical data), and can be retrained whenever new data is obtained. Further, the PHM models may be developed by analyzing surface check data or a combination of surface check data and downhole operational data. In certain embodiments, the inclusion of surface check data in the PHM model development may allow tool failures to be detected or predicted at the surface, prior to directing the tool into the wellbore.

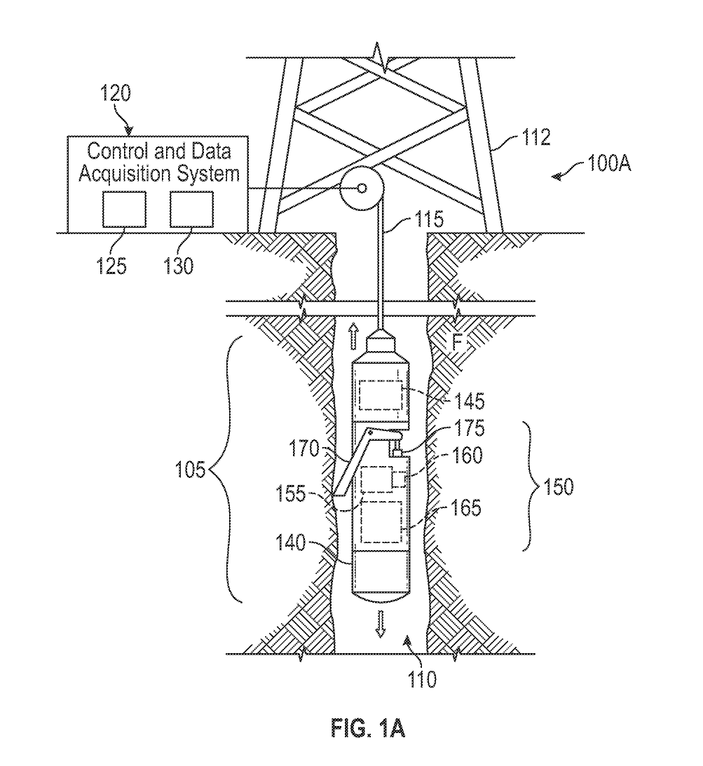

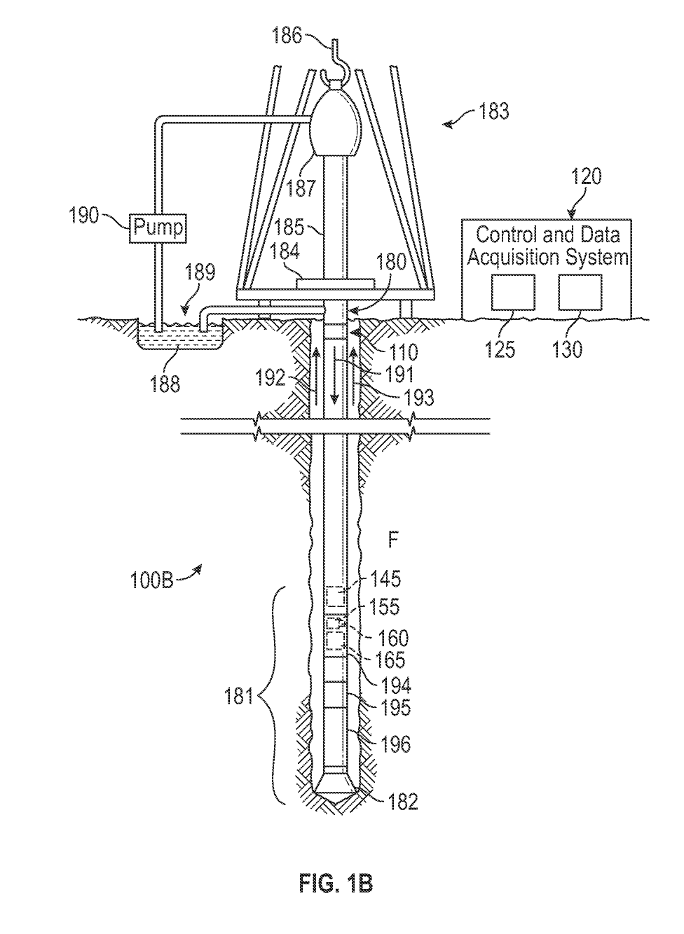

FIGS. 1A and 1B depict examples of downhole tools that may be monitored using PHM. Although FIGS. 1A and 1B depict examples of coring downhole tools, the PHM techniques described herein may be employed to monitor any suitable downhole tool. For example, the PHM techniques described herein may be employed to monitor formation pressure testing tools, imaging tools, pulse neutron generator tools, tractors, formation pressure while drilling (FPWD) tools, and sampling while drilling (SWD) tools, among others. Further, the PHM techniques described herein may be employed to monitor tool health for entire toolstrings or for individual modules or submodules included within a toolstring.

FIG. 1A depicts an example of a wireline system 100A that includes a downhole tool, represented as a coring module 150 designed to extract core samples from a subterranean formation F into which a wellbore 110 has been drilled. The wireline system 100A of FIG. 1A may be situated onshore (as shown) or may be located offshore. The wireline assembly 105 containing the coring module 150 is suspended from a rig 112 into the wellbore 110 and may be suspended in the wellbore 110 at the lower end of a multi-conductor cable 115, which may be spooled on a winch (not shown) at the Earth's surface. At the surface, the cable 115 may be communicatively and/or electrically coupled to a control and data acquisition system 120. The control and data acquisition system 120 includes a controller 125 and a processor 130. In certain embodiments, the controller 125 may include an interface designed to receive commands from an operator. The controller 125 may operate in conjunction with the processor 130 to control the extraction and storage of core samples by the wireline assembly 105. Further, the controller 125 may include a non-volatile memory designed to store algorithms, executable code, and/or look up tables that may be employed by to perform the PHM techniques described herein.

The wireline assembly 105 includes a housing 140 that encloses a telemetry module 145 and the coring module 150. The telemetry module 145 of FIG. 1A may include a downhole control system (not shown) communicatively coupled to the control and data acquisition system 120. In certain embodiments, the downhole control system may control operation of the coring module 150 based on signals received from the control and data acquisition system 120 as well as signals received from sensors, valves, and other components included within the coring module 150. Although the telemetry module 145 of FIG. 1A is shown as a separate module from the coring module 150, the telemetry module 145 may alternatively be integrated with the coring module 150. Further, additional or alternative components and modules, such as packers, stabilizers, formation pressure testing modules, power modules, hydraulic modules, fluid analyzer modules, formation fluid sampling modules, and imaging modules, among others, may be included within the wireline assembly 105. For example, a formation testing module may be employed to draw formation fluid into the wireline assembly 105 so that various measurements on the fluid may be performed to determine any number or type of formation properties and conditions, such as the fluid pressure in the formation F, the permeability of the formation F, and the bubble point of the formation fluid. In another example, a formation sampling module may be employed to draw formation fluid into the wireline assembly 105 and to store the formation fluid in sample chambers included within the wireline assembly 105.

The coring module 150 of FIG. 1A includes a coring apparatus 155 having a coring bit assembly 160 that may be operated to obtain a core sample from the formation F. The coring bit assembly 160 includes a hollow drill bit, commonly referred to as a coring bit, that is advanced into the formation F to remove a core sample from the formation F. The coring module 150 also includes a storage area 165 designed to store the core samples taken from the formation F. For example, the storage area 165 may receive the sample cores, which may be disposed in a sleeve, canister, or other holder within the storage area 165. A brace arm 170 may be provided to stabilize the coring module 150 in the wellbore 110 when the coring bit assembly 160 is operating. The brace arm 170 of FIG. 1A may be selectively controlled and positioned with a piston 175, which may be activated to engage the arm 170 against the surface of the wellbore 110 to stabilize the coring module 105 within the wellbore 110. For example, the arm 170 may be extended until the side of the downhole tool 105 having the coring bit assembly 160, which is opposite the arm 170, engages the surface of the wellbore 110.

The core sample may be removed from the coring module 150 at the surface and analyzed to assess, among other things, the reservoir storage capacity (e.g., porosity) and permeability of the material that makes up the formation F; the chemical and mineral composition of the fluids or mineral deposits contained in the pores of the formation F; and the irreducible water content of the collected formation material. The information obtained from analysis of a core sample also may be used to make formation exploitation and/or production decisions.

FIG. 1B depicts an example of a wellsite drilling system 100B that includes a downhole tool, represented as a logging while drilling (LWD) module 194 disposed within a bottom hole assembly (BHA) 181. The LWD module 194, which may be housed within a drill collar, includes the coring apparatus 155, the coring bit assembly 160, and the storage area 165. The BHA 181 may be employed to form the borehole 110 in the subsurface formation F by rotary or directional drilling. For example, as shown in FIG. 1B, the BHA 181 is suspended from a drill string 180 and includes a drill bit 182 at its lower end.

At the surface, the wellsite drilling system 100B includes a platform and derrick assembly 183 positioned over the borehole 110, as well as the control and data acquisition system 120. The assembly 183 may include a rotary table 184, a kelly 185, a hook 186, and a rotary swivel 187. The drill string 180 may be rotated by the rotary table 184, which engages the kelly 185 at the upper end of the drill string 180. Further, the drill string 180 may be suspended from the hook 186, which may be attached to a traveling block (not shown), and through the kelly 185 and the rotary swivel 187, which permits rotation of the drill string 180 relative to the hook 186.

In the example of FIG. 1B, the surface system 100B also may include drilling fluid 188, commonly referred to as mud, stored in a pit 189 formed at the wellsite. A pump 190 may deliver the drilling fluid 188 to the interior of the drill string 180 via a port (not shown) in the swivel 187, causing the drilling fluid 188 to flow downwardly through the drill string 180 as indicated by the directional arrow 191. The drilling fluid 188 may exit the drill string 180 via water courses, nozzles, jets and/or ports in the drill bit 182, and then circulate upwardly through the annulus region between the outside of the drill string 180 and the wall of the wellbore 110, as indicated by the directional arrows 192 and 193. The drilling fluid 188 may be used to lubricate the drill bit 182 and carry formation cuttings up to the surface, where the drilling fluid 188 may be cleaned and returned to the pit 189 for recirculation. The drilling fluid 188 also may be used to create a mudcake layer (not shown) on the walls of the wellbore 110. It should be noted that in some implementations, the drill bit 182 may be omitted and the bottom hole assembly 181 may be conveyed via coiled tubing and/or pipe.

As noted above, the BHA 181 includes the LWD module 194 that can be employed to extract core samples from the subterranean formation F. The BHA 181 also may include additional downhole tools or modules. For example, the BHA 181 includes the telemetry module 194, a measurement while drilling (MWD) module 195, a rotary-steerable system or mud motor 196, and the drill bit 182. The MWD module 195 is housed in a drill collar and contains one or more devices for measuring characteristics of the drill string 180 and the drill bit 182. The MWD tool 195 also may include an apparatus (not shown) for generating electrical power for use by the downhole system 181. Example devices to generate electrical power include, but are not limited to, a mud turbine generator powered by the flow of the drilling fluid, and a battery system. Example measuring devices include, but are not limited to, a weight-on-bit measuring device, a torque measuring device, a vibration measuring device, a shock measuring device, a stick/slip measuring device, a direction measuring device, and an inclination measuring device. Additionally or alternatively, the MWD module 195 may include an annular pressure sensor, and a natural gamma ray sensor. The MWD module 195 also may include capabilities for measuring, processing, and storing information, as well as for communicating with the control and data acquisition system 120. For example, the MWD module 195 and the control and data acquisition system 120 may communicate information either way (i.e., uplink and downlink) using a two-way telemetry system, such as a mud-pulse telemetry system, a wired drillpipe telemetry system, an electromagnetic telemetry system and/or an acoustic telemetry system.

The systems 100A and 100B depicted in FIGS. 1A and 1B are provided by way of example, and are not intended to be limiting. In other embodiments, the systems 100A and 100B may additional downhole modules and/or tools, or other combinations of downhole modules and/or tools, that are operatively connected together. The modules are may be connected by field joints. For example, each module of a wireline assembly may have one type of connector at its top end and a second type of connector at its bottom end. The top and bottom connectors are made to operatively mate with each other. By using modules and/or tools with similar arrangements of connectors, the modules and tools may be connected end-to-end to form the wireline assembly 105 or the BHA 181. A field joint may provide an electrical connection, a hydraulic connection, and/or a flowline connection, depending on the requirements of the tools on the wireline. An electrical connection may provide both power and communication capabilities. Although the PHM techniques are described below with respect to the coring module 150 and the LWD module 194, the PHM techniques described herein may be employed to monitor any suitable tools or modules included within the wireline assembly or BHA. For example, in certain embodiments, the PHM techniques described herein may be employed to monitor the health of the MWD module.

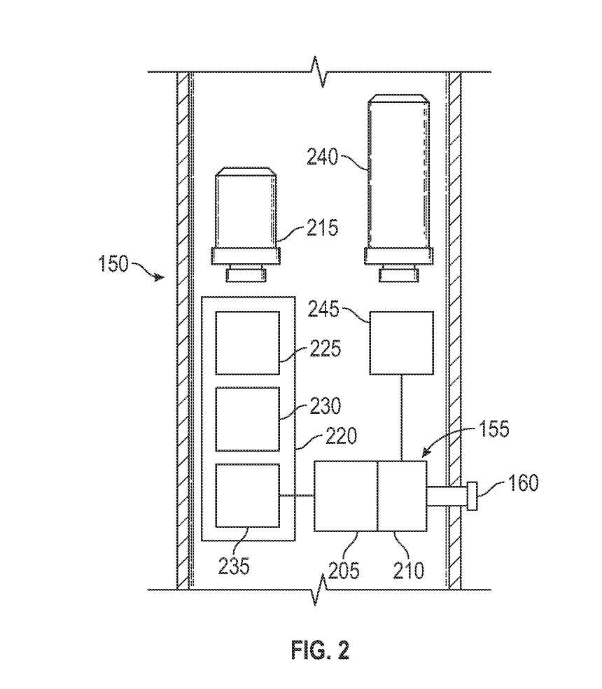

FIG. 2 is a schematic illustration of the coring module 150 according to one or more aspects of the present disclosure. Although not specifically shown in FIG. 2, the LWD module 194 may include features similar to those shown in FIG. 2 and may operate in a manner similar to that described below. As noted above, the coring module 150 includes the coring apparatus 155 having the coring bit assembly 160. The coring module 150 also includes a hydraulic coring motor 205, which may be operatively coupled to the coring bit assembly 160 via a gear box 210, to rotationally drive the coring bit assembly 160 so that the coring bit assembly 160 may cut into the formation F and obtain a core sample.

To drive the coring bit assembly 160 into the formation, the coring bit assembly 160 may be pressed into the formation F while it is rotated. Thus, the coring module 150 may apply a weight on bit (WOB) force that presses the coring bit assembly 160 into the formation F and may apply a torque to the coring bit assembly 160. FIG. 2 schematically depicts mechanisms for applying both of these forces. For example, the WOB may be generated by a motor 215, which may be an AC, brushless DC, or other power source, and a control assembly 220. The example control assembly 220 of FIG. 2 may include a hydraulic pump 225, a feedback flow control (FFC) valve 230, and a piston 235. The motor 215 supplies power to the hydraulic pump 225, while the flow of hydraulic fluid from the pump 225 is regulated by the FFC valve 230. The pressure of the hydraulic fluid drives the piston 235 to apply a WOB to the coring bit assembly 160, as described in greater detail below. The torque may be supplied by another motor 240, which may be an AC, brushless DC, or other power source, and a gear pump 245. The second motor 240 drives the gear pump 245, which supplies a flow of hydraulic fluid to the hydraulic coring motor 205. The hydraulic coring motor 205, in turn, imparts a torque or rotational force to the coring bit assembly 160 via the gear box 210.

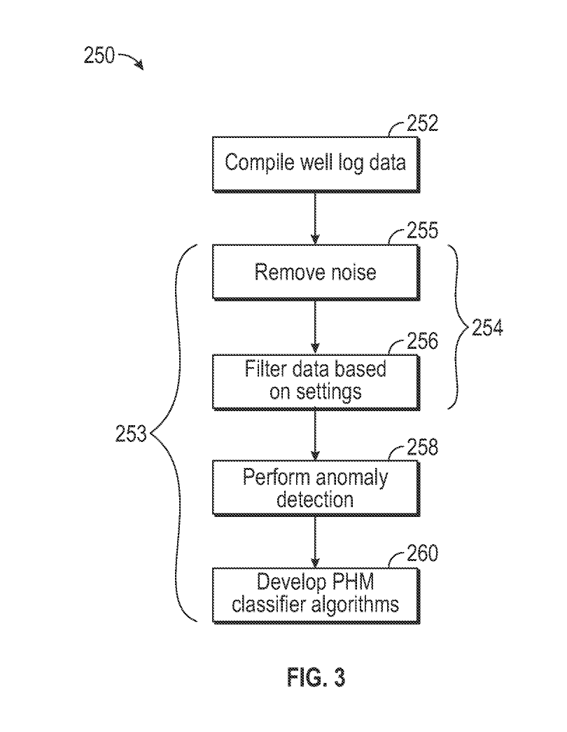

FIG. 3 depicts a method 250 for developing a PHM model based on historical surface check data. The method 250 may begin by compiling (block 252) historical well log data. For example, data collected from previous field tests and prior downhole tool operations may be collected in a database for analysis. In certain embodiments, the data may be collected with a computer at the surface using a data acquisition system. The collected data may include tool parameters, such as run time, voltages, currents, pressures, temperatures, valve positions, and motor positions, among others. In one example, tool parameters for the coring module 150 (FIG. 2) may include run time, current and voltage for the hydraulic coring motor 205, pressure for the hydraulic pump 225, kinematic pressure, and status of a solenoid (not shown) indicating the position of the coring bit 160, among others. Certain tool parameters may be raw data collected by the control and data acquisition system 120, while other tool parameters may be calculated from the raw data.

In addition to data collected during downhole operation of the tool, the well log data may include data collected during tool surface checks. For example, prior to positioning the tool downhole, tool operation may be simulated in a surface check. During the surface check, conditions, such as pressures, temperatures, loads, torques, vibrations, and the like, may be simulated while collecting data for the tool. The data from the surface check may be transmitted to the control and data acquisition system 120 and stored as well log data.

The data from downhole tool operation and surface checks may include a tool health identifier that indicates whether the data is for a healthy tool or for an unhealthy tool (e.g., a tool where a failure has occurred). Moreover, in certain embodiments, for unhealthy tools, the data may include one or more failure identifiers indicating the type of failure that occurred. For example, in the coring module 150, failure identifiers may indicate whether the tool failure was due to failure of the gear pump 245, failure of the motor 240, or failure of the hydraulic coring motor 205, among others.

The well log data may be obtained using various sensors and indicators, such as pressure sensors, temperature sensors, and valve position indicators, among others, that may be included within the downhole tool. Further, the raw data may include environmental and operational data. For example, the coring module 150 may include pressure sensors and temperature sensors, as well as a downhole controller that governs operation of the motors 215, 240, and 205 and pumps 225 and 245. The downhole controller may store data over time representing the current and voltage for the motors 215, 240, and 205, the hydraulic pump pressure, the core sample number, and the position of the coring bit, among others. Further, the downhole controller may include a non-volatile memory that stores executable code and/or algorithms for governing operation of the coring module 150 and recording data. Further, in certain embodiments, instead of, or in addition to, storing the data within the downhole controller, the data may be transmitted to the control and data acquisition system 120, for example, via the telemetry module 145.

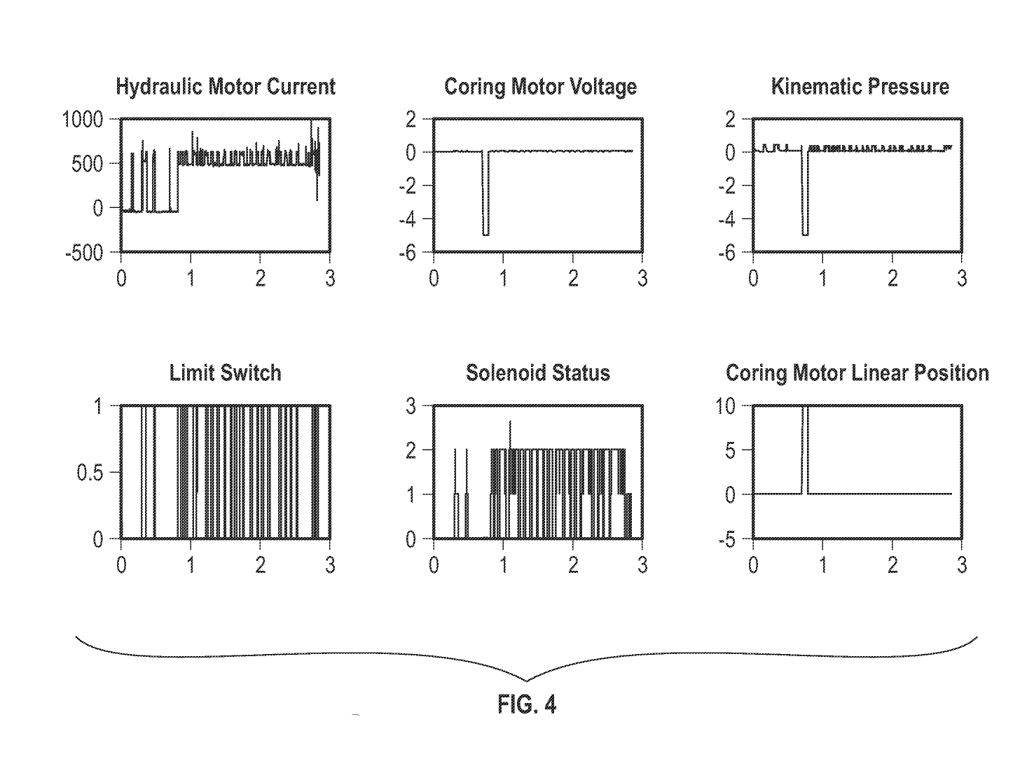

Once the well log data has been compiled (block 253), the method may continue by training 253 (representing blocks 255-260) algorithms on the well log data. FIG. 4 depicts an example of well log data that can be employed to train algorithms. The well log data may include various types of data such as environmental data, operational data, and failure data. The training 253 may include preprocessing 254 the data to remove (block 255) noise and to filter (block 256) the data based on settings. After preprocessing 254, anomaly detection can be performed (block 258) by developing methods based on unsupervised on supervised learning to detect anomalies in the data. The training 253 continues by developing (block 260) classifiers that will: 1) provide diagnostic information for new data points; and 2) predict whether the tool has a particular failure and will not be able to complete the job after surface check. The training may be initially performed using historical data, and the resulting algorithms can be retrained as new failures and/or conditions are observed. In certain embodiments, the algorithms may be executed by the surface data and acquisition system 120 (FIGS. 1 and 2). When the method is employed in a new job, the method will provide a health assessment of the tool, and can be employed to predict whether a particular failure will occur.

Several steps are undertaken in the training process 253. The first step includes preprocessing 254 the data. Several approaches to preprocess the data are available. Some methods may be based on correlations and some methods may employ the domain knowledge of the system, among others. Preprocessing the data ensures that the data is in a suitable format for further analysis and include removing (block 255) noise. For example, the time series data may be plotted or analyzed to remove outliers, such as points with a certain degree of deviation.

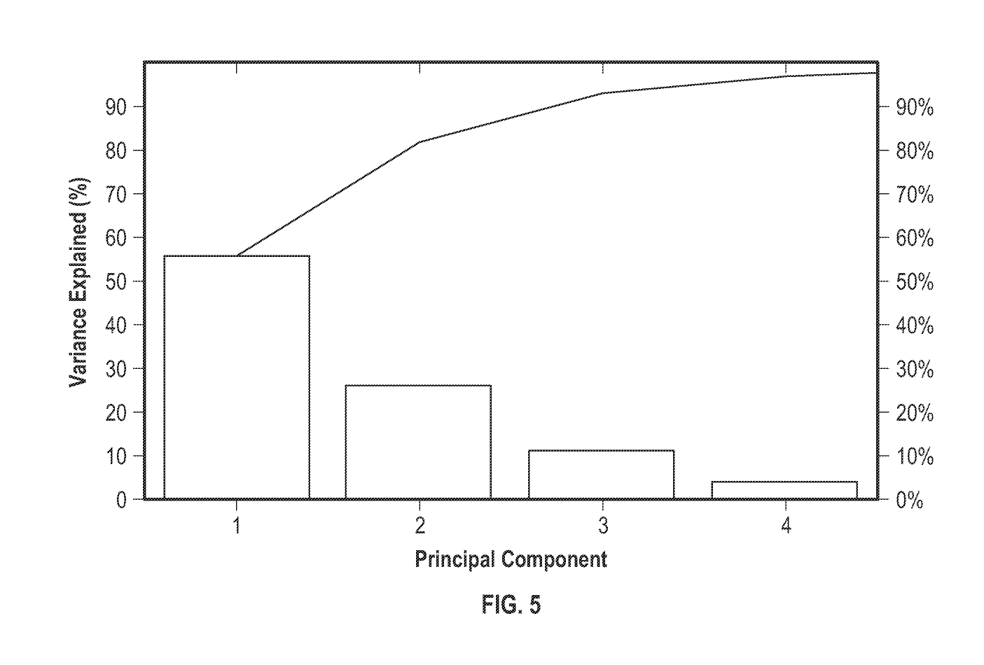

After the time series data has been preprocessed by noise removal (block 255) to remove redundant data and outliers, the data may be filtered (block 256) and features may be selected. Training the classification methods on features derived from the raw data can lead to improved classification results. For example, as shown in FIG. 5, a statistical technique such as principal component analysis may be employed to determine the data components that have the largest possible variance. FIG. 5 depicts a principal component plot that shows the top four principal components that account for the variance in the data. The x-axis shows the principal components, and the y-axis shows the percent variance for which each component is responsible.

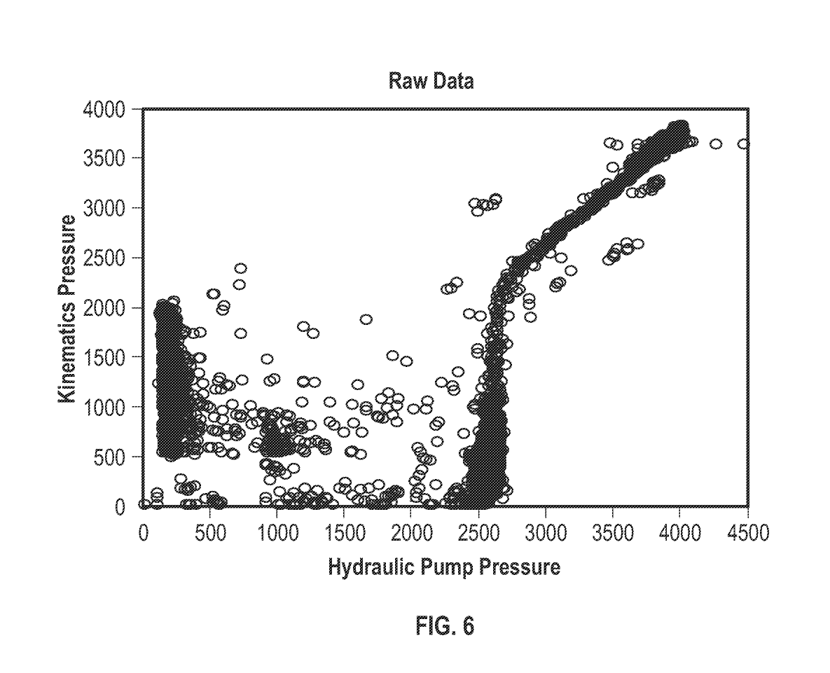

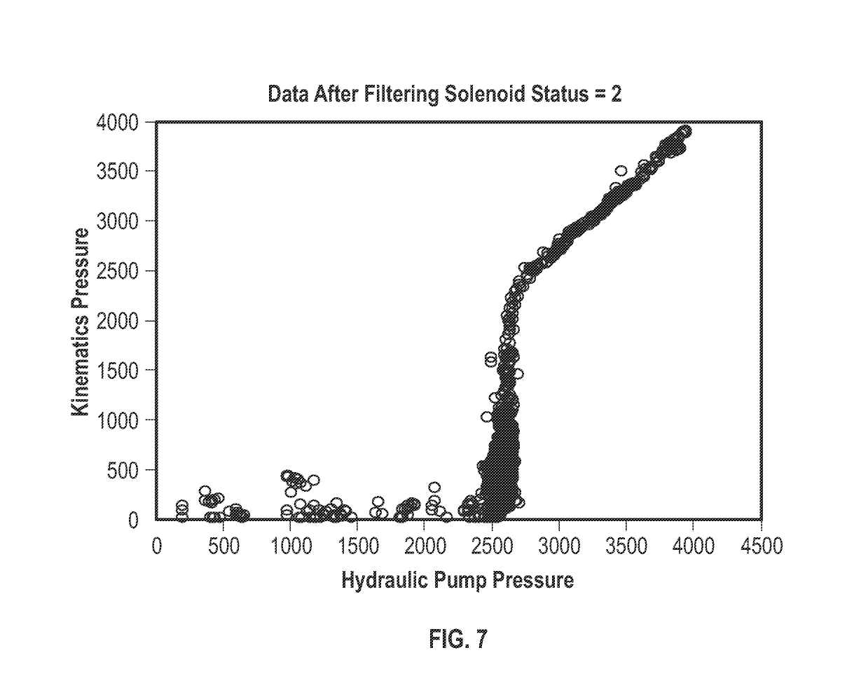

The identified tool parameters can then be analyzed to determine if variance can be reduced by eliminating one or more settings for those tool parameters. For example, as shown in FIG. 5, one component (e.g., principal component 1) accounts for the majority of the variance in the data. FIG. 6 depicts a scatter plot for two variables from the raw data, and FIG. 7 shows the same variables after filtering the data. There are numerous filters that can be applied to the data and number of features that can be identified from the raw signal; those may be application dependent.

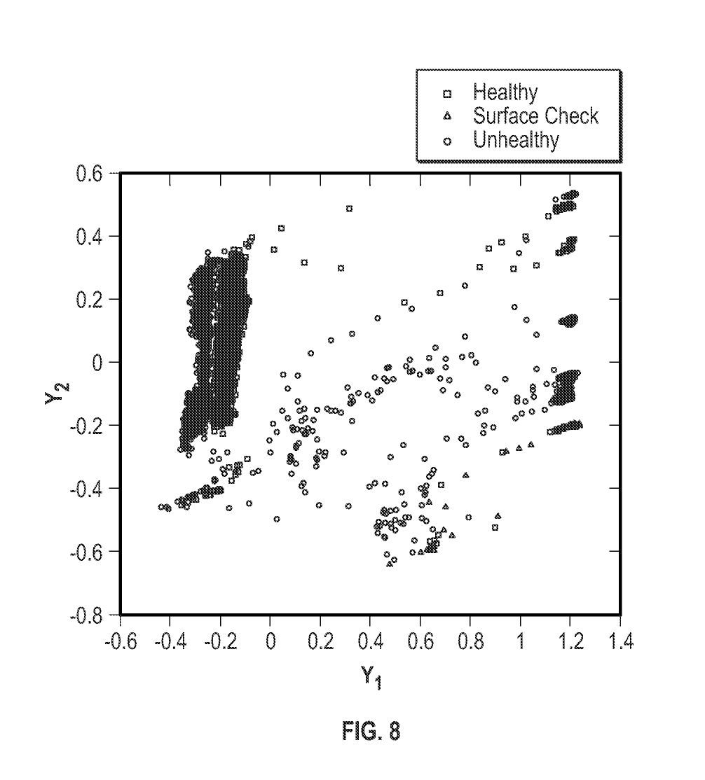

The method may then continue by detecting (block 258) anomalies in the data that can be employed to predict the health of the tool. For example, cluster analysis (e.g., clustering) may be performed to group data points that are similar. FIG. 8 depicts one example of a cluster analysis that may be performed on data for the coring module 150. FIG. 8 depicts the overall analysis performed for a healthy run and for an unhealthy run (e.g., included a tool failure). As shown in FIG. 8, separation exists between healthy and unhealthy states. The method shown in FIG. 8 depicts one approach for anomaly detection. However, other approaches, such as hierarchical clustering, k-means clustering, and self-organization maps, can be used as well.

After the data is preprocessed 254 and put in a format that is suitable for analysis, anomaly detection is performed (block 258) to detect separation between healthy and unhealthy data points, as described above. Then, a classifier is trained on a sample data set that includes failure data and healthy data to develop (block 260) PHM classifier algorithms. Failure data may include multiple failure modes. The classifier receives many types of inputs including raw data, calculated data, and/or features that are obtained from feature selection methods, among others.

The classification algorithms may be generated as functions that define the boundaries of data representing healthy and unhealthy runs. According to certain embodiments, a technique, such as random forests, may be employed to generate the prediction of different classes (such as healthy and unhealthy). Further, in certain embodiments, the PHM algorithms may be functions that define the classifier boundaries and that provide a flag that indicates whether the data to be analyzed is within the classifier boundaries, and therefore a healthy tool, or outside the classifier boundaries, and therefore an unhealthy tool. Further, in certain embodiments, the PHM algorithms may be designed to provide an indicator of how far from healthy data any incoming data point falls. Moreover, in certain embodiments, the PHM algorithms may be designed to identify the specific type of failure. According to certain embodiments, the PHM algorithms may be designed to analyze surface check data, downhole operational data, or combinations thereof.

The techniques described above provide examples of techniques that may be employed to process the surface check and downhole operation data to identify tool parameters that may be employed in the PHM algorithms. According to certain embodiments, these techniques may be performed by statistical software and programs and may be based on machine learning. Further, the PHM algorithms may be designed to provide a prediction of when a failure is likely to occur. Accordingly, in certain embodiments, functions may be developed and incorporated into the PHM algorithms to provide an indication of the time to failure.

The PHM algorithms may be integrated into a PHM model that can be stored on a non-transitory tangible computer readable medium. In certain embodiments, the PHM model may be stored in a non-volatile memory of the control and data acquisition system 120 (FIGS. 1 and 2). The PHM model may then be executed by the controller 125 and/or the processor 130 to detect tool health at the wellsite. Further, in certain embodiments, the PHM model may be run on a computer system operating in a lab or other suitable location. A surface check may be simulated at these sites to detect tool health, which may provide early detection of a tool failure, which assists in determining tool availability and job scheduling.

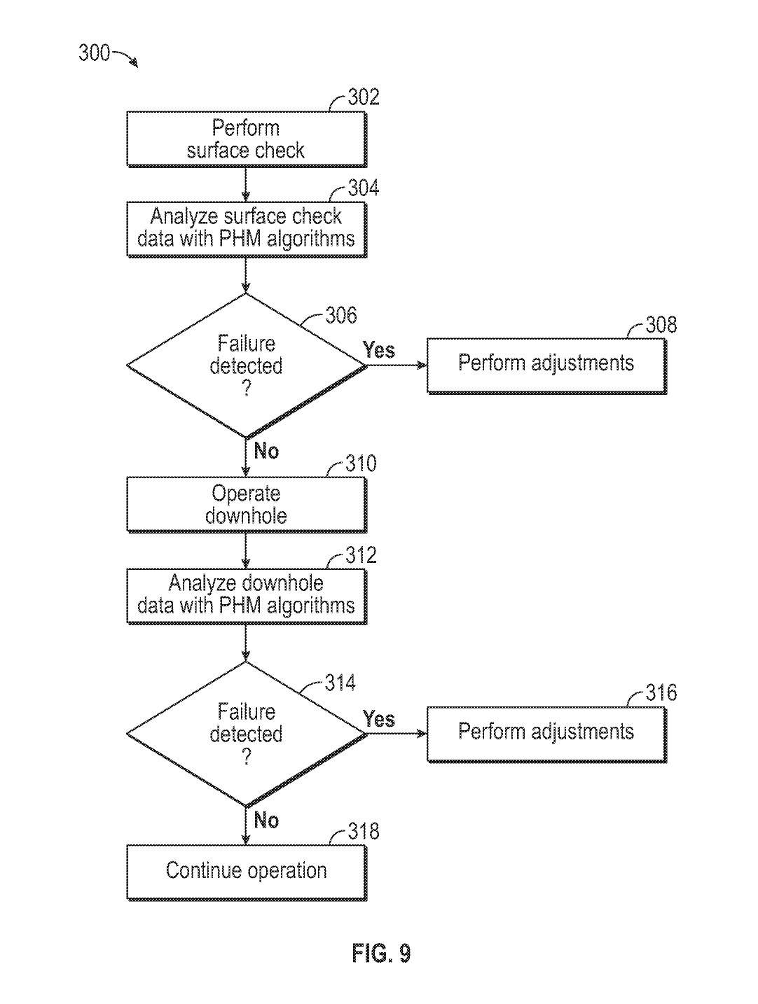

FIG. 9 depicts a method 300 that may be performed at the wellsite to detect tool health using the PHM models. According to certain embodiments, one or more aspects of the method 300 may be performed by the control and data acquisition system 120. The method 300 may begin by performing (block 302) a surface check. For example, operation of the downhole tool may be simulated and data from the tool sent to the control and data acquisition system 120. In certain embodiments, simulation of the downhole tool may be achieved by providing a load box, dynamometer, thermal blankets or other devices that recreate the conditions experienced while the tool is in operation. The control and data acquisition system 120 may then analyze (block 304) the data with the PHM model and associated algorithms to detect the tool health. The control and data acquisition system 120 may then determine (block 306) if a failure is detected. In certain embodiments, the PHM model may output a flag indicating whether the tool is healthy or unhealthy. Further, in certain embodiments, the PHM model may provide data indicating the type of failure. Moreover, the PHM model may provide data indicating that length of time before a failure is expected to occur. According to certain embodiments, the control and data acquisition system 120 may include a display or other user interface designed to display the PHM analysis results to an operator.

If a failure is detected, adjustments may be performed (block 308). For example, in certain embodiments, an operator may replace the downhole tool or replace or repair portions of the downhole tool. As noted above, the detection of a failure prior to lowering the tool into the wellbore may improve efficiency at the wellsite and reduce lost time.

On the other hand, if a failure is not detected, the tool may be operated (block 310) downhole. During downhole operation, the PHM model may be employed to analyze (block 312) the downhole data. For example, in certain embodiments, the downhole tool data may be transmitted to the control and data acquisition system 120, for example, through the telemetry module 145 (FIG. 1). The control and data acquisition 120 may analyze (block 312) the data and output a flag or other indicator of tool health. Further, in certain embodiments, the PHM model may be stored within the downhole tool and executed by the downhole controller. In these embodiments, the downhole controller may analyze (block 150) the data and determine tool health. Flags or other indicators of tool health may then be transmitted to the surface, for example using telemetry.

The control and data acquisition system 120 may then determine (block 314) if a failure is detected. For example, the control and data acquisition system 120 may receive the flag or other indicator from the PHM model and provide an output to a display or other user interface indicating the failure. If a failure is detected, adjustments may be performed (block 316). For example, the control and data acquisition system 120 may adjust operating parameters of the downhole tool in response to determining that a failure has been detected. According to certain embodiments, the control and data acquisition system 120 may adjust parameters such as a motor speed, an allowed current level, or an operating pressure, among others. In certain embodiments, the type of parameter adjustment may be determined based on the type of failure detected or anticipated by the PHM model. Further, in other embodiments, an operator may determine the type of adjustment based on data output by the data control and acquisition system. Moreover, in certain embodiments, the adjustments may be initiated automatically by the PHM model in response to detecting a tool failure or potential tool failure. On the other hand, if a failure is not detected, operation of the downhole tool may continue (block 318).

According to certain embodiments, the PHM model may be designed to analyze data continuously or at set intervals throughout operation of the downhole tool. As noted above, the PHM model may be designed to provide early detection of a tool failure, which in certain embodiments, may allow adjustments to be made to reduce the likelihood of a tool failure.

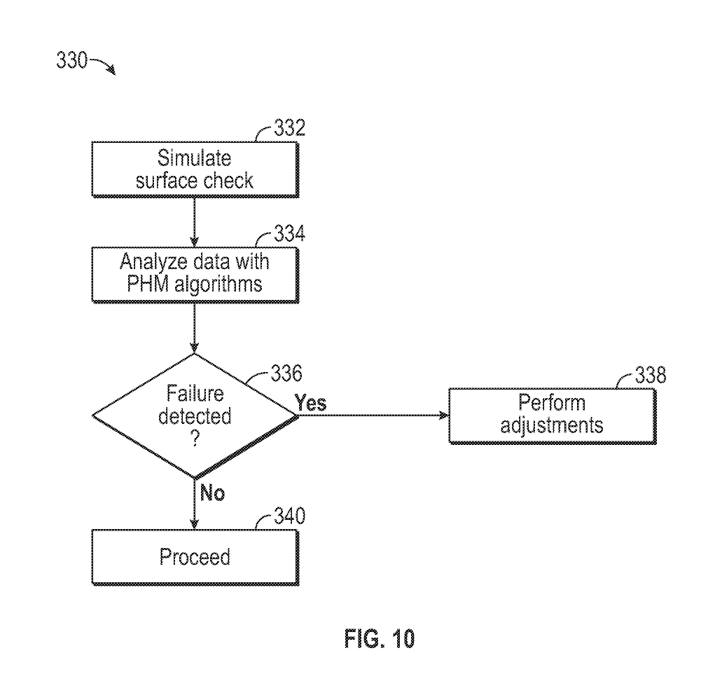

FIG. 10 depicts a method 330 that may be performed remote from the wellsite to detect tool health using the PHM models. For example, the method 330 may be performed on the tool manufacturing floor or in a lab. According to certain embodiments, one or more aspects of the method 330 may be performed by a computer system or other suitable control system, which may include one or more processors as well as non-volatile storage. In certain embodiments, the PHM algorithms developed by method 250 (FIG. 3) may be stored in the non-volatile storage and executed by the one or more processors.

The method 330 may begin by simulating (block 332) a surface check. In certain embodiments, equipment similar to that employed at the wellsite may used on the manufacturing floor or lab to simulate the surface check. For example, a load box, dynamometer, thermal blankets or other devices that recreate the conditions experienced while the tool is in operation may be employed to simulate the surface check. The computer system may then analyze (block 334) the data with the PHM model and associated algorithms to detect the tool health. The computer system may then determine (block 336) if a failure is detected. In certain embodiments, the PHM model may output a flag indicating whether the tool is healthy or unhealthy. Further, in certain embodiments, the PHM model may provide data indicating the type of failure. Moreover, the PHM model may provide data indicating that length of time before a failure is expected to occur. According to certain embodiments, the computer system may include a display or other user interface designed to display the PHM analysis results to an operator.

If a failure is detected, adjustments may be performed (block 338). For example, in certain embodiments, an operator may replace the downhole tool or replace or repair portions of the downhole tool. Moreover, in certain embodiments, additional troubleshooting techniques and/or diagnostics may be employed to isolate the cause of the failure. Further, an operator may adjust job scheduling to allow another tool to be employed at the wellsite. The detection of a failure prior to sending the tool to the wellsite may facilitate job scheduling. On the other hand, if a failure is not detected, the operator may proceed (block 340) with the current job schedule and the tool may be sent to a wellsite or listed as available for a job.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method comprising:
analyzing historical surface check data to train classifiers indicative of data separation between healthy and unhealthy downhole tools; and
developing, based on the classifiers, prognostics health and management algorithms to predict failures in the downhole tools.

2. The method of claim 1, wherein analyzing historical surface check data comprises removing noise from the historical surface check data.

3. The method of claim 1, wherein analyzing historical surface check data comprises filtering the historical surface check data based on component settings for the downhole tools.

4. The method of claim 1, wherein analyzing historical surface check data comprises detecting anomalies in the historical surface check data that indicate the data separation between the healthy and unhealthy downhole tools.

5. The method of claim 1, wherein developing prognostics and health management algorithms comprises defining functions representing the classifiers to define boundaries of healthy and unhealthy data.

6. The method of claim 1, comprising analyzing historical downhole operational data to train the classifiers.

7. The method of claim 1, wherein analyzing historical surface check data comprises identifying features indicative of the data separation between healthy and unhealthy downhole tools and filtering the historical surface check data based on the identified features.

8. A method comprising:
performing a surface check on a downhole tool to generate surface check data; and
analyzing the surface check data using prognostic health management algorithms to determine health of the downhole tool.

9. The method of claim 8, wherein the prognostic health management algorithms are developed using a combination of historical surface check and historical downhole operational data.

10. The method of claim 8, comprising replacing the downhole tool in response to detecting that the downhole tool has failed or is likely to fail.

11. The method of claim 8, comprising operating the downhole tool in a wellbore to generate downhole operational data.

12. The method of claim 11, comprising analyzing the downhole operational data using the prognostic health management algorithms to determine the health of the downhole tool.

13. The method of claim 12, wherein analyzing the downhole operational data comprises analyzing the downhole operational data using a downhole controller of the downhole tool.

14. The method of claim 12, comprising automatically adjusting operational parameters of the downhole tool in response to detecting that the downhole tool is unhealthy.

15. The method of claim 8, wherein performing a surface check comprises simulating a surface check.

16. The method of claim 15, comprising adjusting job scheduling in response to determining that the downhole tool is unhealthy.

17. A downhole tool comprising:
a prognostics health management model comprising prognostics health management algorithms developed using historical surface check data; and
a controller configured to automatically adjust operation of the downhole tool based on results of the prognostics health management model.

18. The downhole tool of claim 17, wherein the prognostics health management algorithms are developed using historical downhole operational data.

19. The downhole tool of claim 17, wherein the controller is configured to adjust a motor speed, a current level, or an operating pressure based on the results of the prognostics health management model.

20. The downhole tool of claim 17, wherein the controller is configured to execute the prognostics health management model during a surface check to determine health of the downhole tool.
